(19) United States
(12) Patent Application Publication
(10) Pub. No.: US 2018/0288387 A1
(43) Pub. Date: Oct. 4, 2018

(54) REAL-TIME CAPTURING, PROCESSING, AND RENDERING OF DATA FOR ENHANCED VIEWING EXPERIENCES

(71) Applicant: Intel Corporation, Santa Clara, CA (US)

(72) Inventors: GOWRI SOMANATH, Santa Clara, CA (US); Ginni Grover, Santa Clara, CA (US); Oscar Nestares, San Jose, CA (US)

(73) Assignee: Intel Corporation, Santa Clara, CA (US)

(21) Appl. No.: 15/473,174

(22) Filed: Mar. 29, 2017

(51) Int. Cl. H04N 13/02

(52) U.S. Cl. CPC H04N 13/0203; G06T 17/00; H04N 13/0271

(57) ABSTRACT

A mechanism is described for facilitating real-time capturing, processing, and rendering of data according to one embodiment. A method of embodiments, as described herein, includes facilitating a capturing device to capture data of a scene, where the data includes a video having at least one of a two-and-a-half-dimensional video (2.5D) or a three-dimensional (3D) video. The method may further include processing, in real-time, the data to generate contents representing a 3D rendering of the data, and facilitating a display device to render, in real-time, the contents.

### FIELD

Embodiments described herein relate generally to data processing and more particularly to facilitate real-time capturing, processing, and rendering of data for enhanced viewing experiences.

### BACKGROUND

Cameras, such as depth-sensing cameras, have been used to capture still and video red green blue depth (RGB-D) for personal media, while multiple images and/or depth information have been effectively used for various computer vision and computational photography effects, such as scene understanding, refocus, composition, and cinema-graphs, etc. However, such effects are still visualized in two-dimensional (2D) images and/or videos, resulting in a limited use and experience for the user.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates a computing device employing a real-time data rendering mechanism according to one embodiment.

FIG. 2 illustrates a real-time data rendering mechanism according to one embodiment.

FIG. 3A illustrates an integral display according to one embodiment.

FIG. 3B illustrates a framework for facilitating real-time capturing and rendering of data using color and depth capture and integral display according to one embodiment.

FIG. 3C illustrates a video conferencing setup for facilitating real-time capturing and rendering of data using color and depth capture and integral display according to one embodiment.

FIG. 3D illustrates a method for facilitating real-time capturing and rendering of data using color and depth capture and integral display according to one embodiment.

FIG. 4A illustrates a top view of an integral display according to one embodiment according to one embodiment.

FIG. 4B illustrated images of captured data to generated view for displays according to one embodiment.

FIG. 4C illustrates extreme views and a middle view as generated by replaced background according to one embodiment.

FIG. 4D illustrates an interleave view that is sent to a display for real-time rendering by the display according to one embodiment.

FIG. 4E illustrates images displayed on an integral display based on data captured with a depth-sensing camera snapshot according to one embodiment.

FIG. 5 illustrates a computer device capable of supporting and implementing one or more embodiments according to one embodiment.

FIG. 6 illustrates an embodiment of a computing environment capable of supporting and implementing one or more embodiments according to one embodiment.

### DETAILED DESCRIPTION

In the following description, numerous specific details are set forth. However, embodiments, as described herein, may be practiced without these specific details. In other instances, well-known circuits, structures and techniques have not been shown in details in order not to obscure the understanding of this description.

Embodiments provide for a novel technique to facilitate real-time rendering of multi-dimensional data, such as 2.5D data, on light field displays, where this 2.5D data may be captured using depth-sensing devices, such as Intel® RealSence™ cameras, to new forms of immersive light field displays, such as a form of three-dimensional (3D) displays. This novel technique may be implemented using any number and type of displays, such as integral displays, tensor displays, etc.

For brevity, clarity, and ease of understanding, implementation details like 2.5D data, integral displays, etc., are referenced throughout this document; however, it is contemplated and to be noted that embodiments are not limited as such.

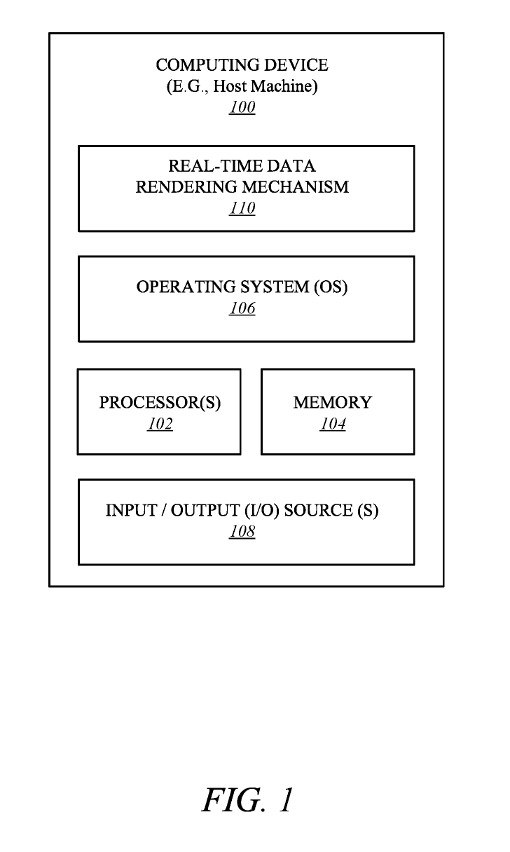

FIG. 1 illustrates a computing device 100 employing a real-time data rendering mechanism (“real-time mechanism”) 110 according to one embodiment. Computing device 100 represents a communication and data processing device including (but not limited to) smart wearable devices, smartphones, virtual reality (VR) devices, head-mounted display (HMDs), mobile computers, Internet of Things (IoT) devices, laptop computers, desktop computers, server computers, etc.

Computing device 100 may further include (without limitations) an autonomous machine or an artificially intelligent agent, such as a mechanical agent or machine, an electronics agent or machine, a virtual agent or machine, an electro-mechanical agent or machine, etc. Examples of autonomous machines or artificially intelligent agents may include (without limitation) robots, autonomous vehicles (e.g., self-driving cars, self-flying planes, self-sailing boats, etc.), autonomous equipment (self-operating construction vehicles, self-operating medical equipment, etc.), and/or the like. Throughout this document, “computing device” may be interchangeably referred to as “autonomous machine” or “artificially intelligent agent” or simply “robot”.

Computing device 100 may further include (without limitations) large computing systems, such as server computers, desktop computers, etc., and may further include set-top boxes (e.g., Internet-based cable television set-top boxes, etc.), global positioning system (GPS)-based devices, etc. Computing device 100 may include mobile computing devices serving as communication devices, such as cellular phones including smartphones, personal digital assistants (PDAs), tablet computers, laptop computers, e-readers, smart televisions, television platforms, wearable devices (e.g., glasses, watches, bracelets, smartcards, jewelry, clothing items, etc.), media players, etc. For example, in one embodiment, computing device 100 may include a mobile computing device employing a computer platform hosting an integrated circuit (“IC”), such as system on a chip (“SoC” or “SOC”), integrating various hardware and/or software components of computing device 100 on a single chip.

As illustrated, in one embodiment, computing device 100 may include any number and type of hardware and/or software components, such as (without limitation) graphics processing unit (“GPU” or simply “graphics processor”) 114, graphics driver (also referred to as “GPU driver”, “graphics driver logic”, “driver logic”, user-mode driver (UMD), UMD, user-mode driver framework (UMDF), UMDF, or simply “driver”) 616, central processing unit (“CPU” or simply “application processor”) 112, memory 108, network devices, drivers, or the like, as well as input/output (I/O) sources 104, such as touchscreens, touch panels, touch pads, virtual or regular keyboards, virtual or regular mice, ports, connectors, etc. Computing device 100 may include operating system (OS) 106 serving as an interface between hardware and/or physical resources of the computer device 100 and a user.

It is to be appreciated that a lesser or more equipped system than the example described above may be preferred for certain implementations. Therefore, the configuration of computing device 100 may vary from implementation to implementation depending upon numerous factors, such as price constraints, performance requirements, technological improvements, or other circumstances.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The terms “logic”, “module”, “component”, “engine”, and “mechanism” may include, by way of example, software or hardware and/or combinations of software and hardware.

In one embodiment, real-time mechanism 110 may be hosted or facilitated by operating system 106 of computing device 100. In another embodiment, real-time mechanism 110 may be hosted by or part of graphics processing unit (“GPU” or simply “graphics processor”) 114 or firmware of graphics processor 114. Similarly, in yet another embodiment, real-time mechanism 110 may be hosted by or part of central processing unit (“CPU” or simply “application processor”) 112. In yet another embodiment, real-time mechanism 110 may be hosted by or part of any number and type of components of computing device 100, such as a portion of real-time mechanism 110 may be hosted by or part of operating system 106, another portion may be hosted by or part of graphics processor 114, another portion may be hosted by or part of application processor 112, while one or more portions of real-time mechanism 110 may be hosted by or part of operating system 106 and/or any number and type of devices of computing device 100. It is contemplated that one or more portions or components of real-time mechanism 110 may be employed as hardware, software, and/or firmware.

It is contemplated that embodiments are not limited to any particular implementation or hosting of real-time mechanism 110 and that real-time mechanism 110 and one or more of its components may be implemented as hardware, software, firmware, or any combination thereof.

Computing device 100 may host network interface(s) to provide access to a network, such as a LAN, a wide area network (WAN), a metropolitan area network (MAN), a personal area network (PAN), Bluetooth, a cloud network, a mobile network (e.g., 3^{rd} Generation (3G), 4^{th} Generation (4G), etc.), an intranet, the Internet, etc. Network interface(s) may include, for example, a wireless network interface having antenna, which may represent one or more antenna(e). Network interface(s) may also include, for example, a wired network interface to communicate with remote devices via network cable, which may be, for example, an Ethernet cable, a coaxial cable, a fiber optic cable, a serial cable, or a parallel cable.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

Throughout the document, term “user” may be interchangeably referred to as “viewer”, “observer”, “person”, “individual”, “end-user”, and/or the like. It is to be noted that throughout this document, terms like “graphics domain” may be referenced interchangeably with “graphics processing unit”, “graphics processor”, or simply “GPU” and similarly, “CPU domain” or “host domain” may be referenced interchangeably with “computer processing unit”, “application processor”, or simply “CPU”.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, and the like, may be used interchangeably throughout this document. Also, terms like “job”, “input”, “request”, “message”, and the like, may be used interchangeably throughout this document.

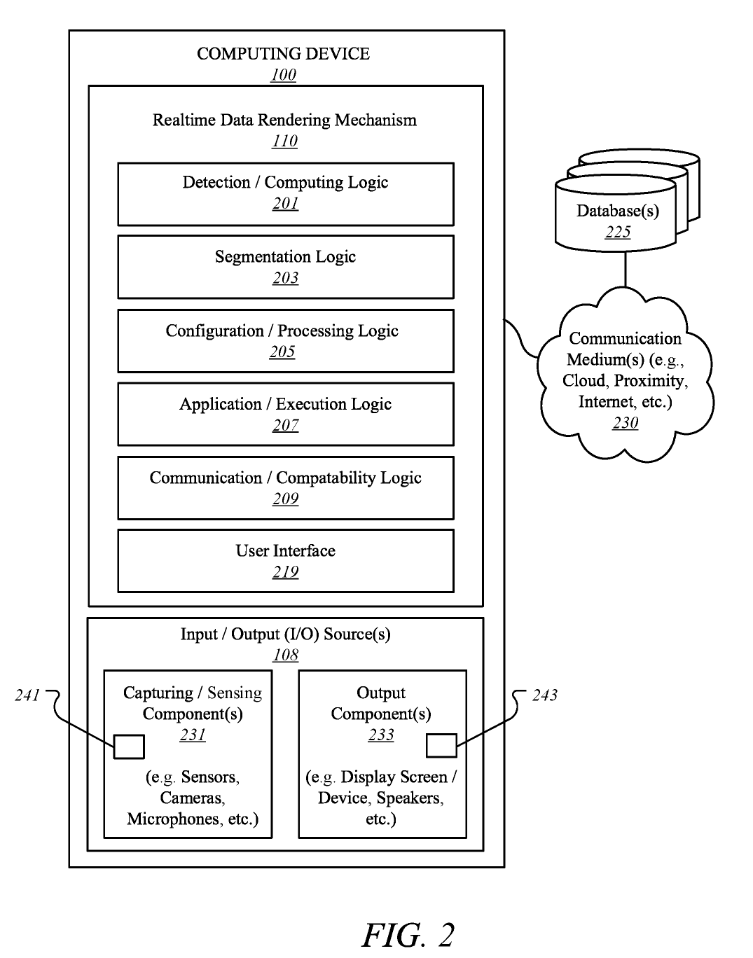

FIG. 2 illustrates real-time mechanism 110 of FIG. 1 according to one embodiment. For brevity, many of the details already discussed with reference to FIG. 1 are not repeated or discussed hereafter. In one embodiment, real-time mechanism 110 may include any number and type of components, such as (without limitations): detection/capturing logic 201; segmentation logic 203; configuration/processing logic 205; application/execution logic 207; communication/compatibility logic 209.

Computing device 100 is further shown to include user interface 219 (e.g., graphical user interface (GUI)-based user interface, Web browser, cloud-based platform user interface, software application-based user interface, other user or application programming interfaces (APIs) etc.). Computing device 100 may further include 1/0 source(s) 108 having capturing/sensing component(s) 231, such as camera(s) (e.g., Intel® RealSense™ camera), and output component(s) 233, such as display(s) (e.g., integral displays, tensor displays, etc.).

Computing device 100 is further illustrated as having access to and/or being in communication with one or more database(s) 225 and/or one or more of other computing devices over one or more communication medium(s) 230 (e.g., networks such as a cloud network, a proximity network, the Internet, etc.).

In some embodiments, database(s) 225 may include one or more of storage mediums or devices, repositories, data sources, etc., having any amount and type of information, such as data, metadata, etc., relating to any number and type of applications, such as data and/or metadata relating to one or more users, physical locations or areas, applicable laws, policies and/or regulations, user preferences and/or profiles, security and/or authentication data, historical and/or preferred details, and/or the like.

As aforementioned, computing device 100 may host I/O sources 108 including capturing/sensing component(s) 231 and output component(s) 233. In one embodiment, capturing/sensing component(s) 231 may include sensor array (such as microphones or microphone array (e.g., ultrasound microphones), cameras or camera array (e.g., two-dimensional (2D) cameras, three-dimensional (3D) cameras, infrared (IR) cameras, depth-sensing cameras, etc.), capacitors, radio components, radar components, etc.), scanners, accelerometers, etc. Similarly, output component(s) 233 may include any number and type of display devices or screens, projectors, speakers, light-emitting diodes (LEDs), one or more speakers and/or vibration motors, etc.

As aforementioned, depth-sensing capturing devices, such as Intel® RealSense™ depth-sensing camera, are known for capturing still and/or video RGB-D for personal media. Such image along with depth information have been effectively used for various computer vision and computational photography effects, such as (without limitations) scene understanding, refocusing, composition, cinema-graphs, etc. However, such effects are still visualized in 2D images and/or videos.

Embodiments provide for a novel technique for using, for example, 2.5D data captured using a depth-sensing camera, such as camera 245, to new forms of immersive light field display, such as a form of 3D displays. This novel technique may be implemented using any number and type of other integral displays, tensor displays, etc.; for brevity, this documents references integral displays for implementation purposes; however, it is to be noted that embodiments are not limited as such.

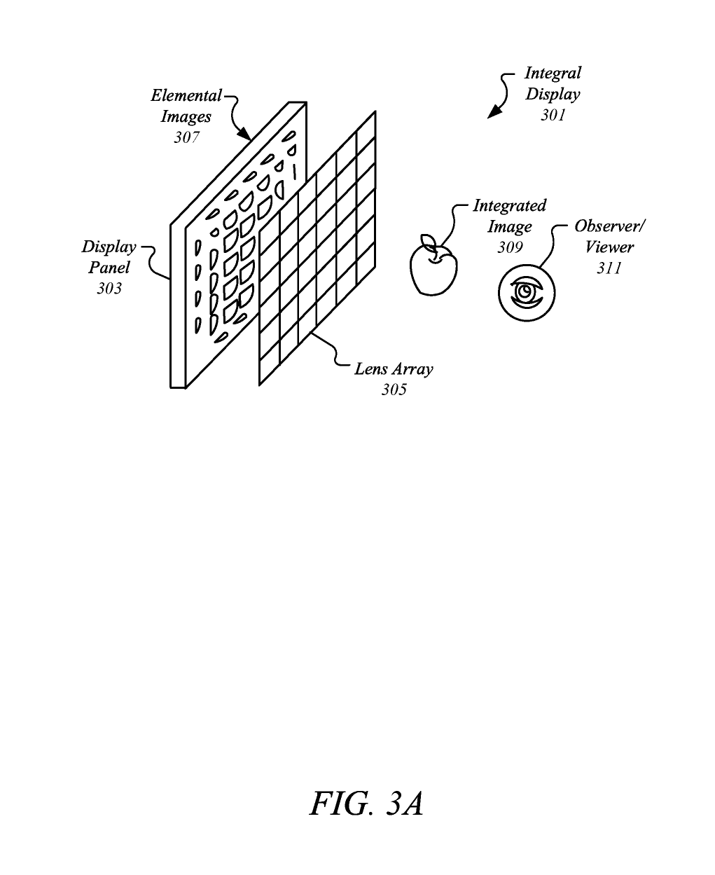

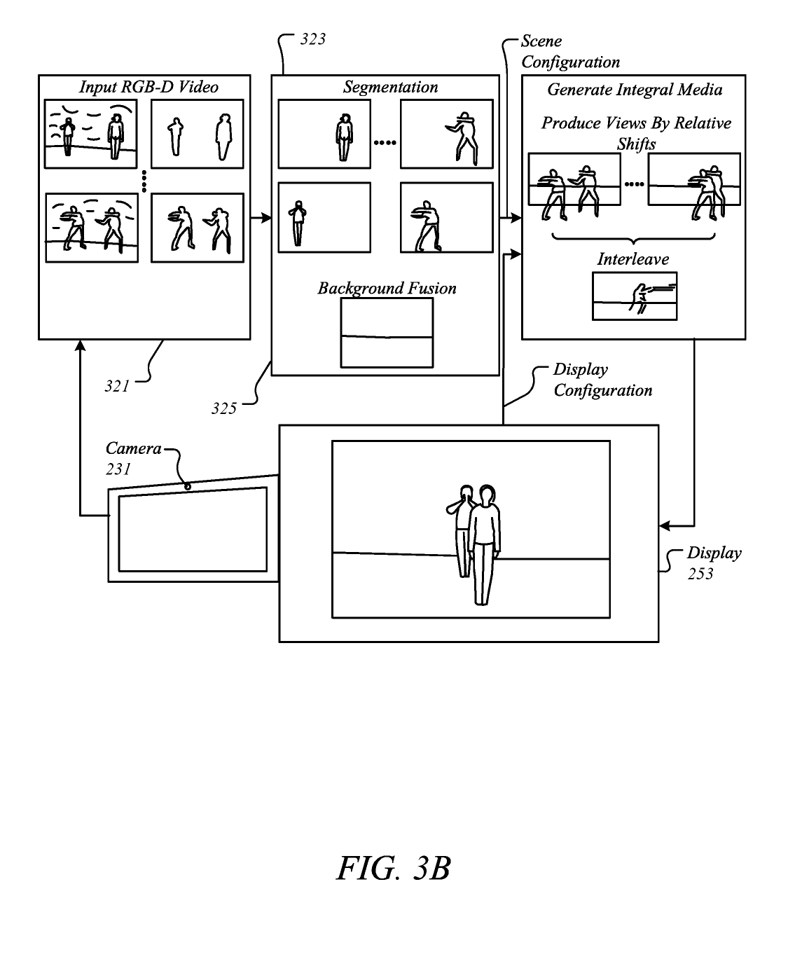

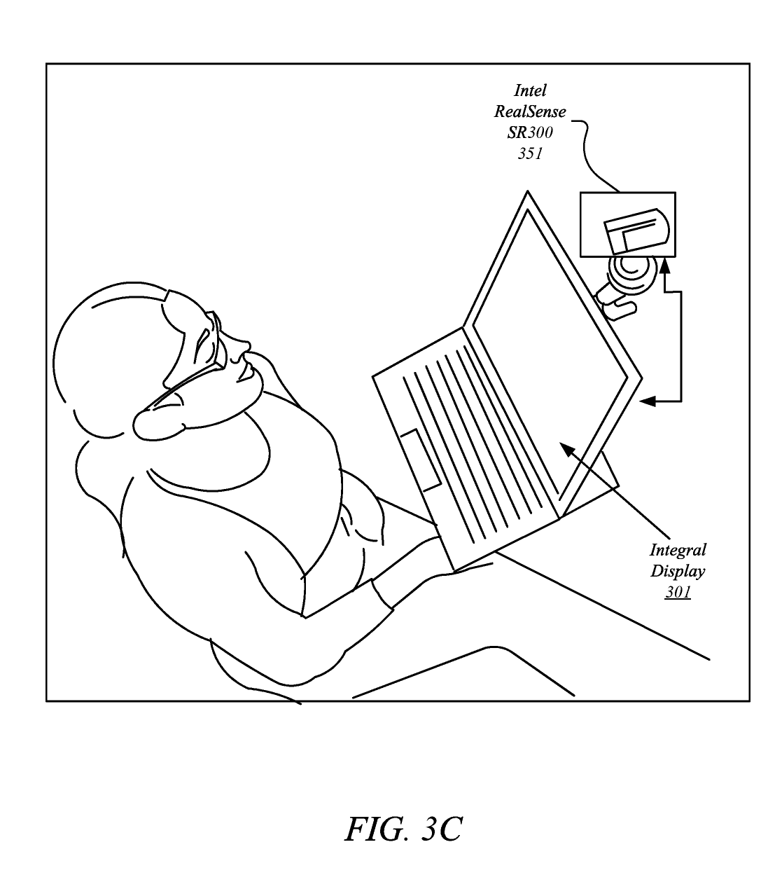

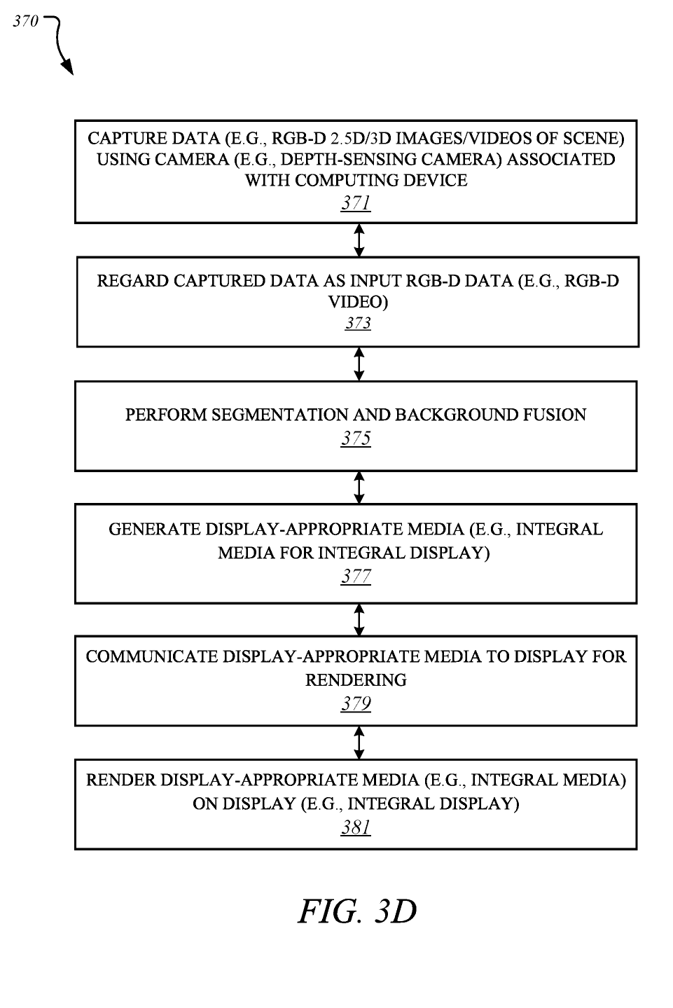

In one embodiment, display device (or simply “display”) 240 may include (but not limited to) an integral display, as illustrated in FIG. 3A, consisting a screen integrated with a lenticular (1D) or lenslet (2D) array in the front, while any images displayed on the screen may consist of tiled elemental images (such as for lenslet) that are constructed by interleaving different views. This allows display 240 to recreate the light field that gives perception of a full 3D scene to the viewer with objects both in front and behind display 240. Now, depending on the density of the views generated by display 240, an observer may experience a parallax and/or retinal blur, making them true 3D displays. These integral display devices, such as display 240, tend to differ from stereoscopic displays in that they do not necessitate 3D glasses for the viewer and further, they are capable of being simultaneously used for multiple viewers.

Embodiments provide for a novel technique for capturing data (such as 2.5D data, 3D data, etc.) relating to one or more objects, scenes, etc., (e.g., humans, trees, cars, buildings, mountains, oceans, etc.) using camera 245 (e.g., RealSense™ camera), as facilitated by detection/capturing logic 201, and then perform various computations and operations for processing of the capture data to use one or more other components, such as facilitated by segmentation logic 203 and configuration/processing logic 205, to then generate multiple views to be rendered on display 240 as facilitated by application/execution logic 207 and communication/compatibility logic 209 and illustrated with reference to FIG. 3B.

In one embodiment, color and depth (RGB-D) still photos and motion videos of one or more objects in a scene, etc., may be captured by one or more cameras 241, such as 2.5D/3D cameras as facilitated by detection/capturing logic 201 of real-time mechanism 110. In one embodiment, any photos, videos, etc., being regarded as data representing the one or more objects in scene may then be processed for segmentation and background fusion, such as segmenting the one or more objects in the scene, by segmentation logic 203 and optional estimation of a clean background using a background fusion logic/algorithm.

It is contemplated that segmentation may refer to an algorithm that is capable of running on one or more cameras 241 or directly on the host, computing device 100, such as on operating system 106. It is contemplated that segmentation intermediate results or such are not desired for or meant to be shown to the end-user for viewing on display 240 and are only discussed and/or shown here as reference and for ease of understanding, where the end-user is likely to have a final rendering or output of contents on display 240, such as on one or more of a lightfield display, a 3D display, an integral display, etc. Further, segmentation may be necessitated for extraction of one or more foreground objects, while background fusion/estimation may be used as an optional technique necessitated when a clean background is desired.

For example, panoramic stitching for any general scene may be improved by combing 2D and 3D based techniques along with object consistency based on scene segmentation to provide clean, consistent, undistorted, and complete images and depths of any scene captured using, for example, a 3D moving camera of camera(s) 241. Further, 2D and 3D pipelines may be selected based on the input scene and parts of the scene may be transformed through the hybrid use of a 2D pipeline and/or a 3D pipeline. For example, for an input sequence of RGB-D frames form a moving camera of any scene, a panoramic scene may be produced such that the panoramic image contains all parts of the scene as captured from the different poses of the moving camera, while generating a corresponding clean disparity/depth panorama and removing or cleaning up of any moving objects of the scene and replacing any corresponding pixels with correct background information in both color and depth.

Upon performance of segmentation by segmentation logic 203, configuration/processing logic 205 may be triggered to compute or learn the display configuration parameters to then generate a set of views that can be like the one captured by an array of cameras 241 by composing the objects on this new/estimated background or a different user defined background that may be a 2D photograph/video or a 2.5D image/video. In one embodiment, using configuration/processing logic 205, the objects in the view or image may be placed at relative depths which may be the same or different from the originally captured data for better visual (3D) perception. The composed images are interleaved to from the elemental images and displayed on integral display, such as display(s) 243, as facilitated by application/execution logic 207.

This novel technique provides for an approach to go from captured 2.5D data, through camera 241, to being display on integral display 243. Traditionally, lightfield cameras or dense cameras have been used to capture scene data for integral displays, where multiple images captured can be directly translated to the multiple views of the display scene. Embodiments provide for a novel technique for generating such multiple views, using RGB and depth captured for camera 241, such as RealSense™ camera, and demonstrate a real-time set using lenticular display, etc.

For example, in one embodiment, detection/capturing logic 201 to facilitate camera(s) 241 (e.g., RealSense™ camera) to use its color and depth capabilities to perform 2.5D/3D capturing of images, videos, etc., of a scene, while segmentation logic 203 to perform segmentation tasks (e.g., real-time RGB-D segmentation) using and based on the captured data (e.g., images, videos, etc.). In one embodiment, configuration/processing logic 205 performs additional configuration and processing tasks on the segmented data to prepare the content for delivery on display 243 (e.g., Lenticular display, Integral display, etc., such as performing scene configuration, generating integral media, adjusting display configurations, etc., and forwards the relevant information to application/execution logic 207 for final processing.

In one embodiment, application/execution logic 207 then uses the contents generate a 3D rendering of the scene for the viewer, where the final 3D scene is then reference on display 243 for an enhanced, more immersive experience for the viewer in display applications, such as video conferencing, video phone calls, video viewing for later, and/or the like. Stated differently, real-time mechanism 110 provides for a real-time final content, as originally captured by camera 241, to integral displays, such as display 243, that are potential candidates for future 3D displays. This novel technique also provides for more applications enabled by RealSense™ cameras by coupling them to new forms of displays.

Given the spatial resolution and depth of field of the integral displays, such as display 243, in one embodiment, views are generated based on RGB-D sequences captured by camera 241, followed by segmentation to extract objects of interest from the sequence. Further, panoramic fusion and background cleaning algorithms may be used to obtain a full texture and depth of the static background in the scene. Then, a simplified 3D model is generated by placing the background and objects (layers) at desired relative depths. Further, given that the depth resolution of both the capture and display devices, such as camera 241 and display 243, are limited, an image-based pipeline may be used to generate new views by shifting each of the layers by the right disparity.

Although there are several image-capturing techniques, conventional techniques do not provide for a system for capturing 2.5D/3D data and generating views based on the capture data. For example, a direct approach would be to capture images and/or videos using an array of cameras or plenoptic camera (such as Lytro) such that the captured images may be directly used as the views for displays, such as display 243. However, finding an exact match between camera parameters, such as baseline, focal length, and integral display parameters like pixel pitch, lenslet resolution, etc., may be difficult.

Further, for example, a single view RGB-D cameras, such as Intel RealSense™, are on a rise, where the depth information can be used to create a 3D reconstruction of the scene, which may then be used to generate the multiple views using view-synthesis algorithms However, this approach fails to provide information in the occlusions, resulting in stretching of color information between the depth/object layers. This reduces motion parallax cue by filing in the wrong depth structure, where, using configuration/processing logic 205, in one embodiment, the use of background fusion allows for recovering of the background information and thus, the effect of looking around the objects may appear more realistic with respect to occlusion. Another potential issue with the reconstruction approach is that any errors and/or holes in depth information may lead to wrong and/or visually displeasing views.

In one embodiment, the use of segmentation as facilitated by segmentation logic 203 allows for placement of objects at relatively depths such that the intended depth information is better conveyed on display 243. Further, in future, it is contemplated that as the pixel density of LCD/LED displays improves, depth-of-field is likely to improve. This novel technique may be easily adapted to those by increasing the number of layers per object to provide for more geometrical information.

Capturing/sensing component(s) 231 may further include one or more of vibration components, tactile components, conductance elements, biometric sensors, chemical detectors, signal detectors, electroencephalography, functional near-infrared spectroscopy, wave detectors, force sensors (e.g., accelerometers), illuminators, eye-tracking or gaze-tracking system, head-tracking system, etc., that may be used for capturing any amount and type of visual data, such as images (e.g., photos, videos, movies, audio/video streams, etc.), and non-visual data, such as audio streams or signals (e.g., sound, noise, vibration, ultrasound, etc.), radio waves (e.g., wireless signals, such as wireless signals having data, metadata, signs, etc.), chemical changes or properties (e.g., humidity, body temperature, etc.), biometric readings (e.g., figure prints, etc.), brainwaves, brain circulation, environmental/weather conditions, maps, etc. It is contemplated that “sensor” and “detector” may be referenced interchangeably throughout this document. It is further contemplated that one or more capturing/sensing component(s) 231 may further include one or more of supporting or supplemental devices for capturing and/or sensing of data, such as illuminators (e.g., IR illuminator), light fixtures, generators, sound blockers, etc.

It is further contemplated that in one embodiment, capturing/sensing component(s) 231 may further include any number and type of context sensors (e.g., linear accelerometer) for sensing or detecting any number and type of contexts (e.g., estimating horizon, linear acceleration, etc., relating to a mobile computing device, etc.). For example, capturing/sensing component(s) 231 may include any number and type of sensors, such as (without limitations): accelerometers (e.g., linear accelerometer to measure linear acceleration, etc.); inertial devices (e.g., inertial accelerometers, inertial gyroscopes, micro-electro-mechanical systems (MEMS) gyroscopes, inertial navigators, etc.); and gravity gradiometers to study and measure variations in gravitation acceleration due to gravity, etc.

Further, for example, capturing/sensing component(s) 231 may include (without limitations): audio/visual devices (e.g., cameras, microphones, speakers, etc.); context-aware sensors (e.g., temperature sensors, facial expression and feature measurement sensors working with one or more cameras of audio/visual devices, environment sensors (such as to sense background colors, lights, etc.); biometric sensors (such as to detect fingerprints, etc.), calendar maintenance and reading device), etc.; global positioning system (GPS) sensors; resource requestor; and/or TEE logic. TEE logic may be employed separately or be part of resource requestor and/or an I/O subsystem, etc. Capturing/sensing component(s) 231 may further include voice recognition devices, photo recognition devices, facial and other body recognition components, voice-to-text conversion components, etc.

Similarly, output component(s) 233 may include dynamic tactile touch screens having tactile effectors as an example of presenting visualization of touch, where an embodiment of such may be ultrasonic generators that can send signals in space which, when reaching, for example, human fingers can cause tactile sensation or like feeling on the fingers. Further, for example and in one embodiment, output component(s) 233 may include (without limitation) one or more of light sources, display devices and/or screens, audio speakers, tactile components, conductance elements, bone conducting speakers, olfactory or smell visual and/or non/visual presentation devices, haptic or touch visual and/or non-visual presentation devices, animation display devices, biometric display devices, X-ray display devices, high-resolution displays, high-dynamic range displays, multi-view displays, and head-mounted displays (HMDs) for at least one of virtual reality (VR) and augmented reality (AR), etc.

It is contemplated that embodiment are not limited to any particular number or type of use-case scenarios, architectural placements, or component setups; however, for the sake of brevity and clarity, illustrations and descriptions are offered and discussed throughout this document for exemplary purposes but that embodiments are not limited as such. Further, throughout this document, “user” may refer to someone having access to one or more computing devices, such as computing device 100, and may be referenced interchangeably with “person”, “individual”, “human”, “him”, “her”, “child”, “adult”, “viewer”, “player”, “gamer”, “developer”, programmer”, and/or the like.

Communication/compatibility logic 209 may be used to facilitate dynamic communication and compatibility between various components, networks, computing devices, database(s) 225, and/or communication medium(s) 230, etc., and any number and type of other computing devices (such as wearable computing devices, mobile computing devices, desktop computers, server computing devices, etc.), processing devices (e.g., central processing unit (CPU), graphics processing unit (GPU), etc.), capturing/sensing components (e.g., non-visual data sensors/detectors, such as audio sensors, olfactory sensors, haptic sensors, signal sensors, vibration sensors, chemicals detectors, radio wave detectors, force sensors, weather/temperature sensors, body/biometric sensors, scanners, etc., and visual data sensors/detectors, such as cameras, etc.), user/context-awareness components and/or identification/verification sensors/devices (such as biometric sensors/detectors, scanners, etc.), memory or storage devices, data sources, and/or database(s) (such as data storage devices, hard drives, solid-state drives, hard disks, memory cards or devices, memory circuits, etc.), network(s) (e.g., Cloud network, Internet, Internet of Things, intranet, cellular network, proximity networks, such as Bluetooth, Bluetooth low energy (BLE), Bluetooth Smart, Wi-Fi proximity, Radio Frequency Identification, Near Field Communication, Body Area Network, etc.), wireless or wired communications and relevant protocols (e.g., Wi-Fi®, WiMAX, Ethernet, etc.), connectivity and location management techniques, software applications/websites, (e.g., social and/or business networking websites, business applications, games and other entertainment applications, etc.), programming languages, etc., while ensuring compatibility with changing technologies, parameters, protocols, standards, etc.

Throughout this document, terms like “logic”, “component”, “module”, “framework”, “engine”, “tool”, and/or the like, may be referenced interchangeably and include, by way of example, software, hardware, and/or any combination of software and hardware, such as firmware. In one example, “logic” may refer to or include a software component that is capable of working with one or more of an operating system, a graphics driver, etc., of a computing device, such as computing device 100. In another example, “logic” may refer to or include a hardware component that is capable of being physically installed along with or as part of one or more system hardware elements, such as an application processor, a graphics processor, etc., of a computing device, such as computing device 100. In yet another embodiment, “logic” may refer to or include a firmware component that is capable of being part of system firmware, such as firmware of an application processor or a graphics processor, etc., of a computing device, such as computing device 100.

Further, any use of a particular brand, word, term, phrase, name, and/or acronym, such as “2.5D”, “3D”, “RGB-D”, “depth-sensing camera”, “RealSense™ camera”, “real-time”, “integral display”, “segmenting”, “fusion background”, “rendering”, “automatic”, “dynamic”, “user interface”, “camera”, “sensor”, “microphone”, “display screen”, “speaker”, “verification”, “authentication”, “privacy”, “user”, “user profile”, “user preference”, “sender”, “receiver”, “personal device”, “smart device”, “mobile computer”, “wearable device”, “IoT device”, “proximity network”, “cloud network”, “server computer”, etc., should not be read to limit embodiments to software or devices that carry that label in products or in literature external to this document.

It is contemplated that any number and type of components may be added to and/or removed from real-time mechanism 110 to facilitate various embodiments including adding, removing, and/or enhancing certain features. For brevity, clarity, and ease of understanding of real-time mechanism 110, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

FIG. 3A illustrates integral display 301 according to one embodiment. For brevity, many of the details previously discussed with reference to FIGS. 1-2 may not be discussed or repeated hereafter. Any processes relating to integral display 301 may be performed by processing logic that may comprise hardware (e.g., circuitry, dedicated logic, programmable logic, etc.), software (such as instructions run on a processing device), or a combination thereof, as facilitated by real-time mechanism 110 of FIG. 1. The processes associated with integral display 301 may be illustrated or recited in linear sequences for brevity and clarity in presentation; however, it is contemplated that any number of them can be performed in parallel, asynchronously, or in different orders.

In one embodiment, integral display 301 may be one of display(s) 243 of FIG. 2, where, as previously discussed with reference to FIG. 2, integral display 301 may contain display panel or screen 303 that is integrated with lens array 305 (such as lenticular 1D array, lenslet 2D arrays) in front. Any image displayed on display panel 303 may include tiled element images 307 (such as for each lenset), which are constructed by interleaving in different ways. Further, this allows for integral display 301 to recreate the light field, offering perception of a full 3D scene, such as integrated image 309, to viewers, such as viewer 311. This integrated image 309 may be seen as floating in and/or around display 301.

Depending on the density of the views generated by display 301, viewer/observer 311 may experience parallax and/or retinal blur, making integrated image 309 a realistic one and display 301 a truly 3D display. This integral display 301 differs from stereoscopic displays as integral display 301, unlike stereoscopic or other conventional displays, does not require 3D glasses from viewer 311 and work for multiple viewer simultaneously.

FIG. 3B illustrates a framework 320 for facilitating real-time capturing and rendering of data using RGB-D capture and integral display according to one embodiment. For brevity, many of the details previously discussed with reference to FIGS. 1-3A may not be discussed or repeated hereafter. Any processes relating to framework 320 may be performed by processing logic that may comprise hardware (e.g., circuitry, dedicated logic, programmable logic, etc.), software (such as instructions run on a processing device), or a combination thereof, as facilitated by real-time mechanism 110 of FIG. 1. The processes associated with framework 320 may be illustrated or recited in linear sequences for brevity and clarity in presentation; however, it is contemplated that any number of them can be performed in parallel, asynchronously, or in different orders. Further, embodiments are not limited to any particular architectural placement, framework, transaction sequence, and/or structure of components and/or processes, such as framework 320.

As illustrated here and described above with reference to FIG. 2, camera 241 (e.g., RealSense™ or similar camera) associated with a processing device, such as computing device 100 of FIG. 1, may be used to capture 2.5D/3D data consisting of still images and/or videos, etc., where this data may then be used by real-time mechanism 110 of FIG. 1 to perform processing to generate multiple views that are then rendered on one or more display devices, such as display 243 including integral display 301 of FIG. 3A.

As described above in reference to FIG. 2, the captured data, such as a 2.5D/3D RGB-D (color+depth) video of a scene having objects, is accepted as an input at block 321 for processing including segmentation of one or more object of the scene at block 323. Further, a clean background is also estimated from a sequence or frames of the entire video through background fusion at block 325.

In one embodiment, at block 327, given the display configuration parameters, a set of views, similar to the ones originally captured in the video, by an array of camera, including camera 241, is generated by composing the objects on the estimated or new background, leading to generation of integral media. Further, these composed images are interleaved to form elemental images that are then rendered for displaying at display 243, such as an integral display.

This novel technique goes from, for example, a real-time capture of 2.5D and/or 3D data by camera 241 to displaying at integral display 243, while generating multiple views using RGB+depth captured by camera 241 and demonstrating a real-time system.

FIG. 3C illustrates a video conferencing setup 350 for facilitating real-time capturing and rendering of data using RGB-D capture and integral display according to one embodiment. For brevity, many of the details previously discussed with reference to FIGS. 1-3B may not be discussed or repeated hereafter. Any processes relating to setup 350 may be performed by processing logic that may comprise hardware (e.g., circuitry, dedicated logic, programmable logic, etc.), software (such as instructions run on a processing device), or a combination thereof, as facilitated by real-time mechanism 110 of FIG. 1. The processes associated with setup 350 may be illustrated or recited in linear sequences for brevity and clarity in presentation; however, it is contemplated that any number of them can be performed in parallel, asynchronously, or in different orders. Further, embodiments are not limited to any particular architectural placement, framework, transaction sequence, and/or structure of components and/or processes, such as setup 350.

As illustrated here and previously discussed with reference to FIG. 2, this novel technique, a facilitated by real-time mechanism 110 of FIG. 1, may be used with any number and type of applications, such as real-time communication applications like video conferencing, video chatting, etc., and non-real-time applications where videos may be played or still photos may be viewed by users at a later point in time. In either case, this novel technique offers a unique and enhanced user experience, such as 3D viewing experience with floating objects, etc., but without having to wear 3D glasses.

The illustrated embodiment provides for setup 350 offering a real-time instantiation of the approach of this novel technique in 3D video conferencing. For example, in the illustrated embodiment, a user is engaged in a 3D video conferencing through setup 350 having a camera, such as Intel® RealSense™ camera SR300 351 and a display including integral display 301, where captured data is processed as discussed with respect to FIG. 2. As described above with reference to FIG. 2, segmentation may be implemented as logic that can run on a camera or on the host computing device, where its results, such as intermediate results, etc., are not regarded as of any interest to the end-user and thus, not displayed on display 301. Such results are discussed and/or shown here merely for discussion purposes.

FIG. 3D illustrates a method 370 for facilitating real-time capturing and rendering of data using RGB-D capture and integral display according to one embodiment. For brevity, many of the details previously discussed with reference to FIGS. 1-3C may not be discussed or repeated hereafter. Any processes relating to method 370 may be performed by processing logic that may comprise hardware (e.g., circuitry, dedicated logic, programmable logic, etc.), software (such as instructions run on a processing device), or a combination thereof, as facilitated by real-time mechanism 110 of FIG. 1. The processes associated with method 370 may be illustrated or recited in linear sequences for brevity and clarity in presentation; however, it is contemplated that any number of them can be performed in parallel, asynchronously, or in different orders. Further, embodiments are not limited to any particular architectural placement, framework, transaction sequence, method, and/or structure of components and/or processes, such as method 370.

Method 370 begins at block 371 with capturing of data (e.g., RGB-D 2.5D and/or 3D images and/or videos of a scene) using one or more depth-sensing cameras (e.g., Intel® RealSense camera) associated with a computing de vice (e.g., desktop, tablet, etc.). At block 373, capture data may then be regarded as an input RGB-D data (e.g., RGB-D video) for proposes of processing. At block 375, one or more processes of segmentation and background fusion are performed based and using the input RGB-data. At block 377, display-appropriate media is generated through scene configuration and display configuration based on the data having gone through segmentation and background fusion. At block 379, the display appropriate media is forwarded on to one or more display devices (e.g., integral display) for rendering of the media. At block 381, the media is rendered or displayed by the display associated with the computing device or other one or more computing devices. It is contemplated that integral media is the image viewed by the viewer/end-user using a display screen, where the integral media is not the image rendered.

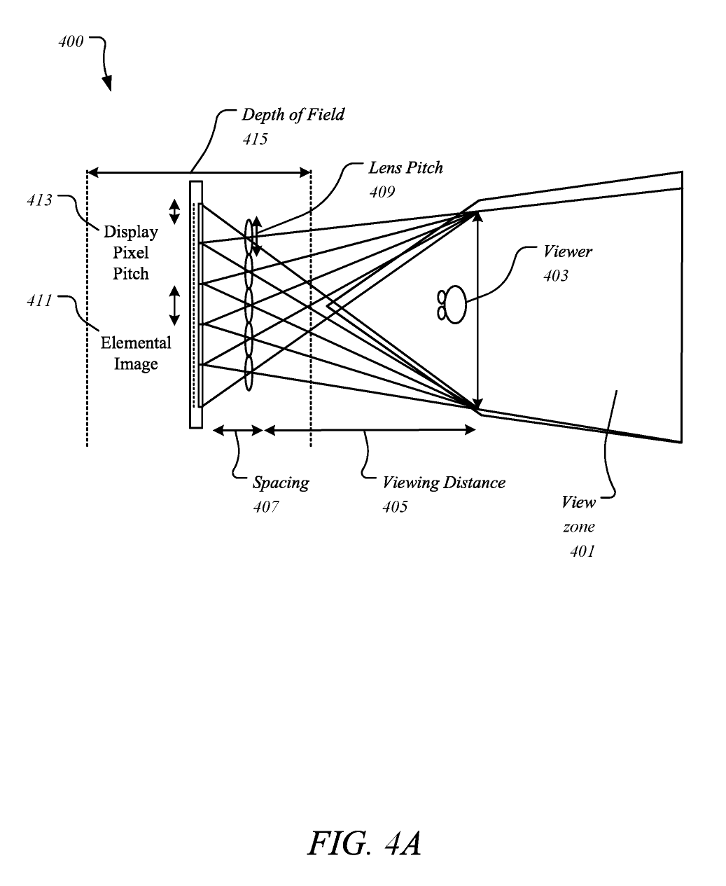

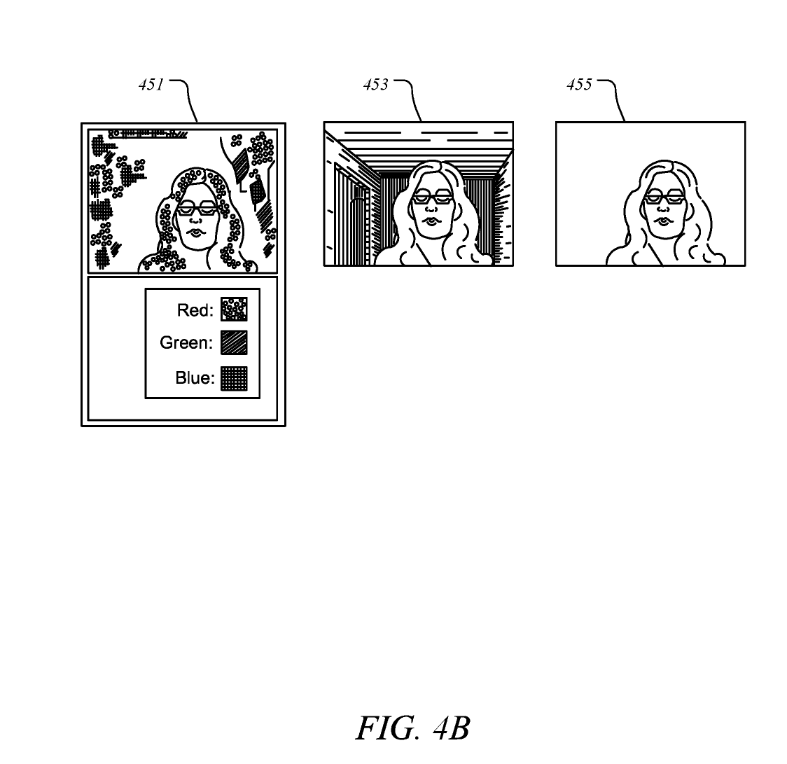

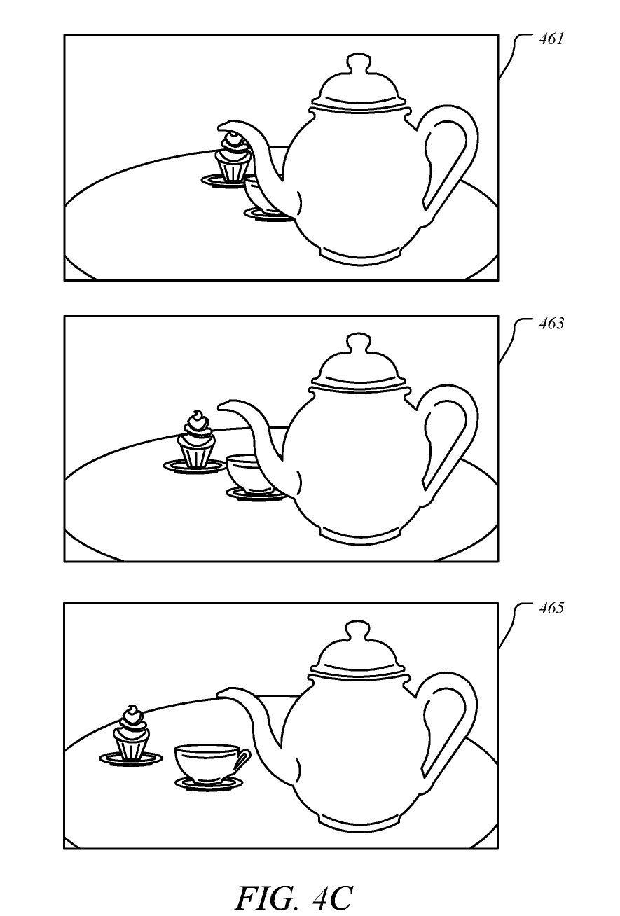

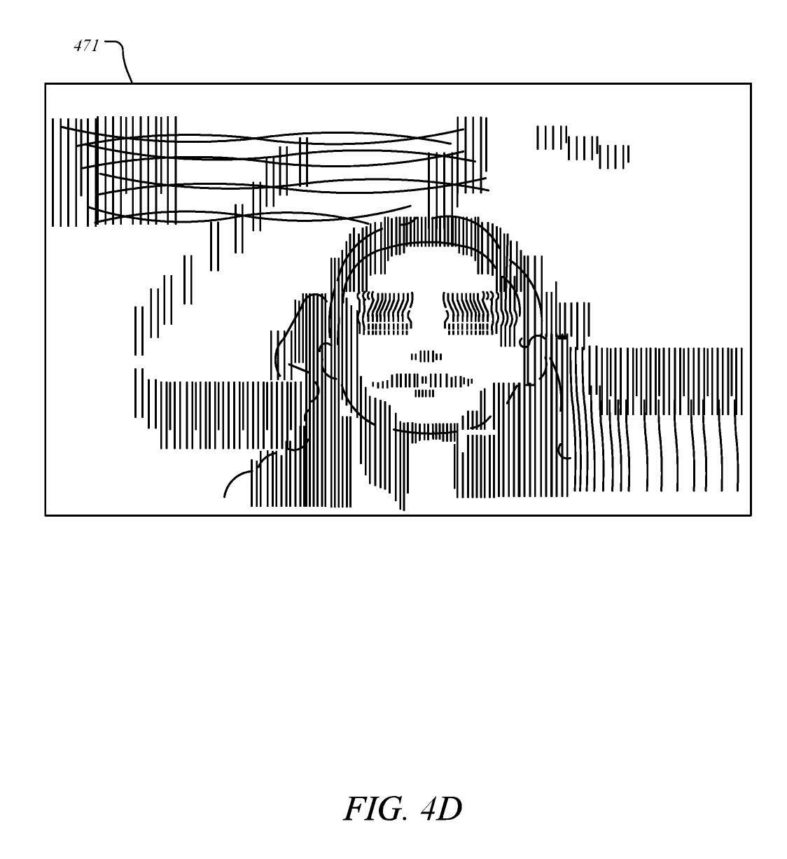

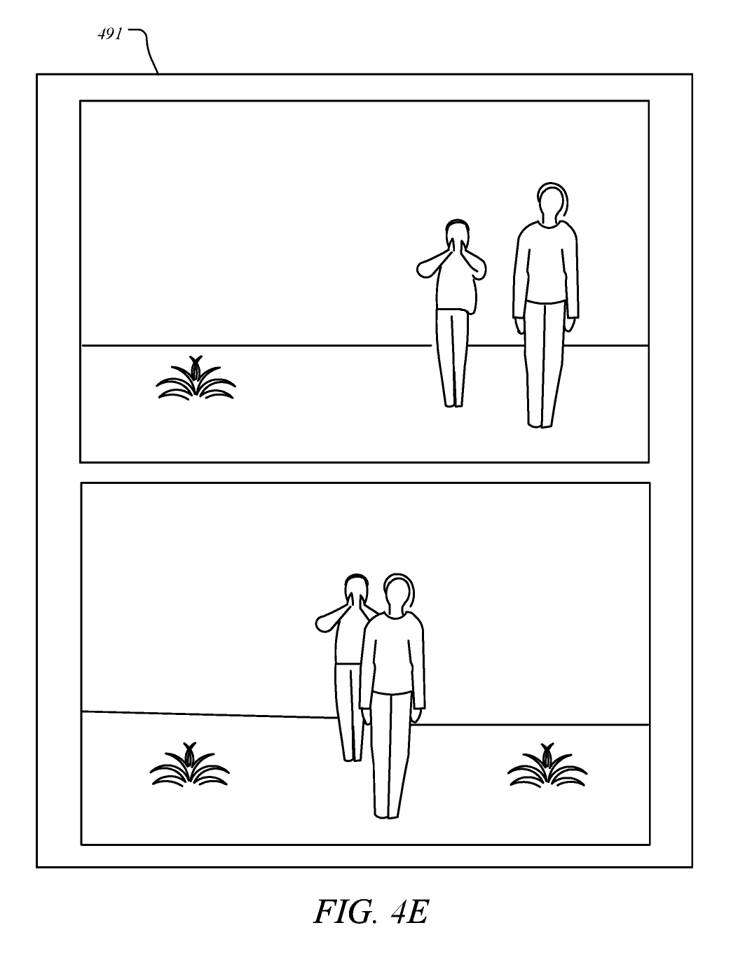

FIG. 4A illustrates top view 400 of integral display 301 of FIG. 3A according to one embodiment. For brevity, many of the details previously discussed with reference to FIGS. 1-3C may not be discussed or repeated hereafter. It is contemplated that all integral display parameter and characteristics shown in 1D are extended in 2D and the region labeled as viewing zone 401 is where viewer 403 can view 3D images.

With regard to the input, as described throughout this document, depth-sensing cameras like Intel® RealSense™ camera (such as R100, R200, SR300, etc.) may be used to capture RGB-D videos of a scene containing one or more objects of interest. These cameras may provide one high resolution color image and corresponding depth map.

With regard to display, as shown with respect to FIG. 3A, a display panel, such as a liquid crystal display (LCD) or light-emitting diode (LED) displays panels, with a 1D or 2D lanslet array in the front may be used. As illustrated here, the integral display characteristics are defined by parameters of both the back display and the lenslet array in the front. In most integral displays, the effective special resolution is limited by lenslet pitch 409, while depth of field 415 of the integral display is limited by product of number of pixels 413 in each elemental image 411 (behind each lens) and the focal length of the lenslets. In addition to spatial resolution and depth of field 415, integral displays exhibit another characteristic, called eyebox or viewing angle or viewing zone 401. Eyebox defines the lateral range, parallel to the display, in which viewer 403 can move to observe clear images. Further, viewing distance 405 and spacing 407 are shown.

For example, if viewer 403 moves outside the eyebox or viewing zone 401, the views can repeat in reverse and there is aliasing at the border of viewing zone 401. Stated differently, for comfortable viewing, both the eyes of viewer 403 are expected to be within the borders of viewing zone 401. Further, viewing zone 401 is generally measured in terms of viewing angle and for most integral displays, the angle may be up to 50 degrees. Also, some displays have a minimum viewing distance according to which if the viewer has to be at least that distance from the display and lenslet combination to view 3D image. It is contemplated that there is a tradeoff between these three characteristics, such as spatial resolution, depth of field 415, and viewing angle. For example, improvements to one of the characteristics may be reduce another and thus, most of the research in integral displays focus on overcoming this tradeoff.

In this embodiment, a basic integral display, such as integral display 301 of FIG. 3A, may be used, where, for example, for a given display pitch 413, lenslet pitch 409, and spacing 407 (between display and lenslet), various characteristics are obtained as follows:

eyebox_width=(display_pitch×n_pixels)×lenslet_pitch/(n_pixels×display_pitch−lenset_pitch) 1)

viewing_distance=spacing×lenslet_pitch/(n_pixels×display_pitch−lenslet_pitch) 2)

depth of field=spacing×n_pixels 3)

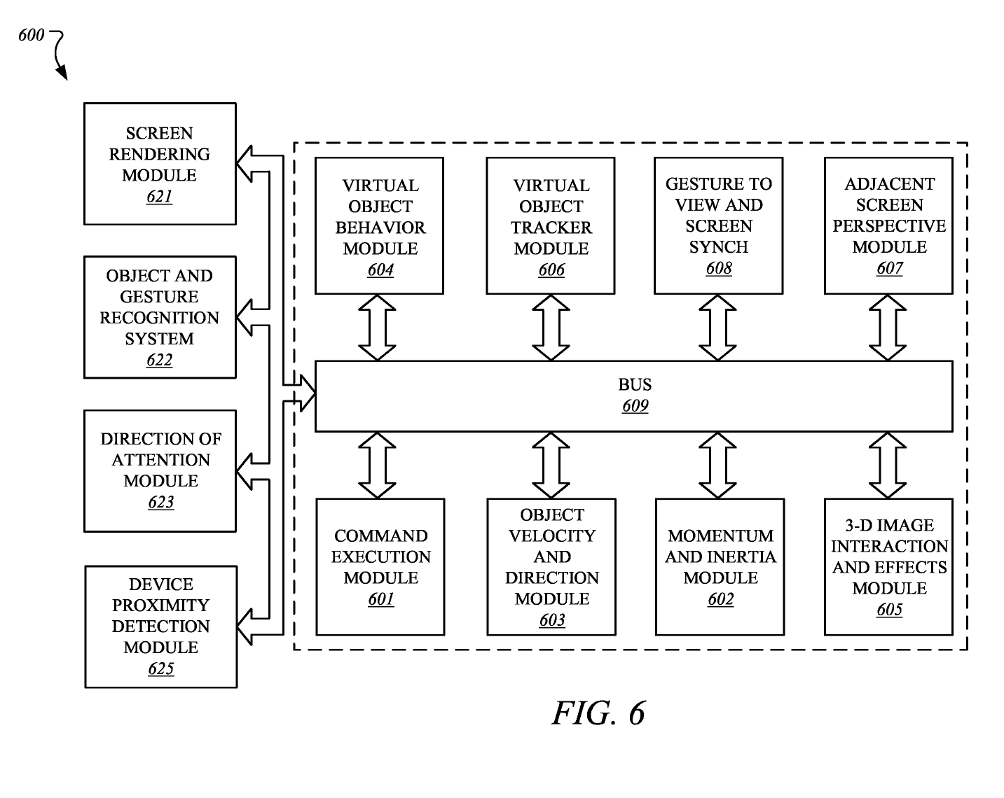

Thus, for a given display and lenslets array combination, the number of pixels, n_pixels, in each elemental image 411 is determined so that an eyebox_width is roughly larger than average human eye separation at a reasonable viewing distance. This way, a correct integral display configuration suitable for naked eye viewing is determined. The n_pixels essentially translates to the number of views generated by the integral display and also, the number of views or camera positions to be generated in processing as facilitated by real-time mechanism 110 of FIG. 6.

Give the LCD or LED display with resolution screen_width×screen_height in pixels, number of views, num_views_x and num_views_y [num_views_x,y=n_pixels, for 1D cases, num_views_y=1], where maximum disparity value, max_disparity [the disparity range goes from −max_disparity to +max_disparity, where disparity 0 corresponds to the lenslet plane. Here, negative appears below the display and positive disparity makes the object appear out of the screen, where negative and positive extremes of disparity map to the edges of depth of field 415], where each view has (screen_width/num_views_x×screen_height/num_views_y) pixels.

With regard to layer extraction, in one embodiment, one or more layers are extracted from the sequence, where in some embodiments, the objects of interest and a clean background are extracted. In one embodiment, RGB-D segmentation is used to extract object and background fusion to obtain clean RGB and depth of background, respectively, where given the limited depth of field 415 of most target displays, these extracted layers are also used in assigning clear depth bins in the display to important scene components. This novel technique allows for freedom to re-compose the scene with the same or different objects with desired relative depths (that are different from the actual scene). For instance, if an object is to be clearly popped out of display, the object can be placed at the further depth planes coming out of the display plane. An alternative to object-based layering is segmentation based on depth layers.

In one embodiment, integral images are generated, where given multiple layers, the scene configuration defines their relative depths. For example, in one embodiment, normalized values of −1.0 to +1.0 are used to correspond to max_disparity based on the display being used. For example, an integral image is generated as follows:

Each layer, L, is first resized to view size, for each pixel L(x′,y′) with depth, d ∈[−1.0, 1.0], for each view v ∈[0, num_views_x), vy ∈[0, num_views_y). For example, shifting of the pixel in columns (1D) or rows and columns (2D) is as follows: L′(x′+sx,y′+sy)=L(x′,y′), where sx=(d*v*max_disparity)/num_views_x and sy=(d*vy*max_disparity)/num_views_y. The pixel at L′(x,y) location in the above view may then be placed into a final interleaved image to be displayed on the LCD as l(v+(x*num_views_x), vy+(y*num_views))=L′(x,y). This final interleaved image, I, is then displayed on the integral display.

FIGS. 4B, 4C, 4D, and 4E illustrate use case scenarios of captured data to generated views according to one embodiment. For brevity, many of the details previously discussed with reference to FIGS. 1-4A may not be discussed or repeated hereafter. As illustrated in FIG. 4B, captured RGB image 451 captured using a depth-sensing camera is shown, followed by segment image 453, and cropped object 455 are shown.

FIG. 4C illustrates extreme views 461, 465 and middle view 463 as generated by replaced background for an 18-view lenticular display. For example, the background is at extreme depth appearing below/inside the display plane, while the person appears to float out/about the display screen. It is to be noted that occlusion and appearance of the background as the views change (e.g., the Intel block in background), as the observer moves left to right, he can look around the front object to see more of the background behind the object.

FIG. 4D illustrates interleaved view 471 that is sent to the display, such as display 243 of FIG. 2, as further described with reference to FIG. 2.

FIG. 4E illustrates images 481 displayed on an integral display based on data captured with a depth-sensing camera snapshot, processed offline and video display on the integral display. Extreme views from a 27-view display, where synthetic (top) and depth-sensing data-based (bottom) as viewed on a computing device, such as a tablet computer. Again, the occlusion helps visualize the effect seen by the user as the background appears to be inside, while the different objects appears to float above. In the illustrated images 481 with two persons, they appear to float at different depths with the person on the right appearing closer to the user (farther from the display plane).

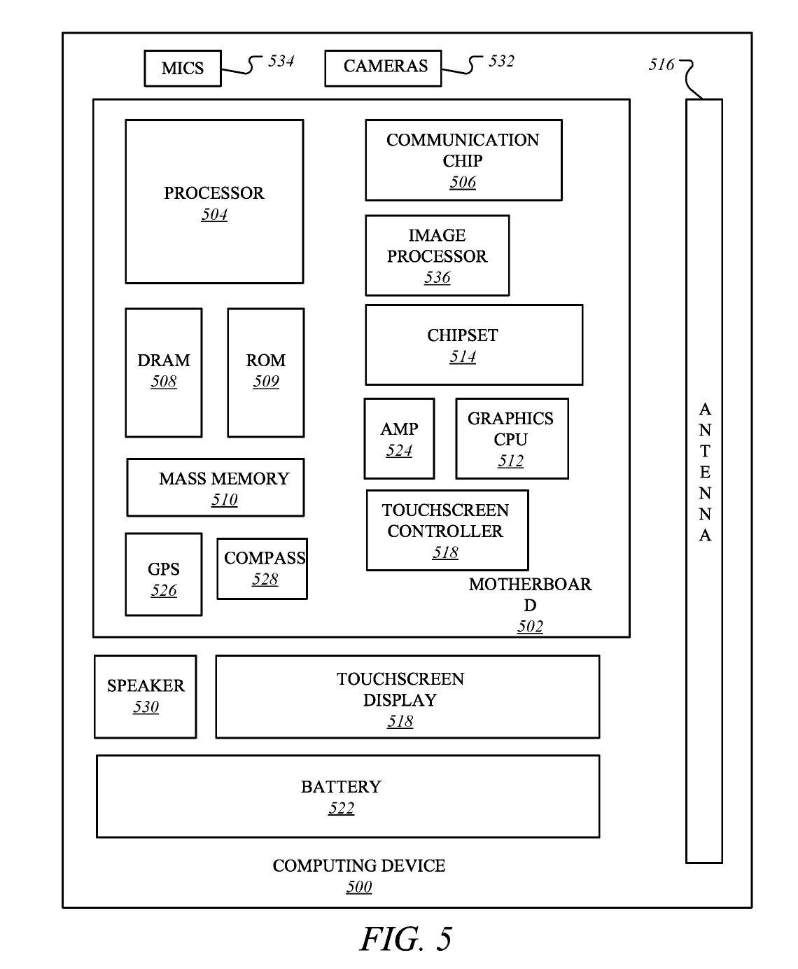

FIG. 5 illustrates a computing device 500 in accordance with one implementation. The illustrated computing device 500 may be same as or similar to computing device 100 of FIG. 1. The computing device 500 houses a system board 502. The board 502 may include a number of components, including but not limited to a processor 504 and at least one communication package 506. The communication package is coupled to one or more antennas 516. The processor 504 is physically and electrically coupled to the board 502.

Depending on its applications, computing device 500 may include other components that may or may not be physically and electrically coupled to the board 502. These other components include, but are not limited to, volatile memory (e.g., DRAM) 508, non-volatile memory (e.g., ROM) 509, flash memory (not shown), a graphics processor 512, a digital signal processor (not shown), a crypto processor (not shown), a chipset 514, an antenna 516, a display 518 such as a touchscreen display, a touchscreen controller 520, a battery 522, an audio codec (not shown), a video codec (not shown), a power amplifier 524, a global positioning system (GPS) device 526, a compass 528, an accelerometer (not shown), a gyroscope (not shown), a speaker 530, cameras 532, a microphone array 534, and a mass storage device (such as hard disk drive) 510, compact disk (CD) (not shown), digital versatile disk (DVD) (not shown), and so forth). These components may be connected to the system board 502, mounted to the system board, or combined with any of the other components.

The communication package 506 enables wireless and/or wired communications for the transfer of data to and from the computing device 500. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication package 506 may implement any of a number of wireless or wired standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, Ethernet derivatives thereof, as well as any other wireless and wired protocols that are designated as 3G, 4G, 5G, and beyond. The computing device 500 may include a plurality of communication packages 506. For instance, a first communication package 506 may be dedicated to shorter range wireless communications such as Wi-Fi and Bluetooth and a second communication package 506 may be dedicated to longer range wireless communications such as GPS, EDGE, GPRS, CDMA, WiMAX, LTE, Ev-DO, and others.

The cameras 532 including any depth sensors or proximity sensor are coupled to an optional image processor 536 to perform conversions, analysis, noise reduction, comparisons, depth or distance analysis, image understanding and other processes as described herein. The processor 504 is coupled to the image processor to drive the process with interrupts, set parameters, and control operations of image processor and the cameras. Image processing may instead be performed in the processor 504, the graphics CPU 512, the cameras 532, or in any other device.

In various implementations, the computing device 500 may be a laptop, a netbook, a notebook, an ultrabook, a smartphone, a tablet, a personal digital assistant (PDA), an ultra mobile PC, a mobile phone, a desktop computer, a server, a set-top box, an entertainment control unit, a digital camera, a portable music player, or a digital video recorder. The computing device may be fixed, portable, or wearable. In further implementations, the computing device 500 may be any other electronic device that processes data or records data for processing elsewhere.

Embodiments may be implemented using one or more memory chips, controllers, CPUs (Central Processing Unit), microchips or integrated circuits interconnected using a motherboard, an application specific integrated circuit (ASIC), and/or a field programmable gate array (FPGA). The term “logic” may include, by way of example, software or hardware and/or combinations of software and hardware.

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified, the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Embodiments may be provided, for example, as a computer program product which may include one or more transitory or non-transitory machine-readable storage media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

FIG. 6 illustrates an embodiment of a computing environment 600 capable of supporting the operations discussed above. The modules and systems can be implemented in a variety of different hardware architectures and form factors including that shown in FIG. 5.

The Command Execution Module 601 includes a central processing unit to cache and execute commands and to distribute tasks among the other modules and systems shown. It may include an instruction stack, a cache memory to store intermediate and final results, and mass memory to store applications and operating systems. The Command Execution Module may also serve as a central coordination and task allocation unit for the system.

The Screen Rendering Module 621 draws objects on the one or more multiple screens for the user to see. It can be adapted to receive the data from the Virtual Object Behavior Module 604, described below, and to render the virtual object and any other objects and forces on the appropriate screen or screens. Thus, the data from the Virtual Object Behavior Module would determine the position and dynamics of the virtual object and associated gestures, forces and objects, for example, and the Screen Rendering Module would depict the virtual object and associated objects and environment on a screen, accordingly. The Screen Rendering Module could further be adapted to receive data from the Adjacent Screen Perspective Module 607, described below, to either depict a target landing area for the virtual object if the virtual object could be moved to the display of the device with which the Adjacent Screen Perspective Module is associated. Thus, for example, if the virtual object is being moved from a main screen to an auxiliary screen, the Adjacent Screen Perspective Module 2 could send data to the Screen Rendering Module to suggest, for example in shadow form, one or more target landing areas for the virtual object on that track to a user's hand movements or eye movements.

The Object and Gesture Recognition System 622 may be adapted to recognize and track hand and arm gestures of a user. Such a module may be used to recognize hands, fingers, finger gestures, hand movements and a location of hands relative to displays. For example, the Object and Gesture Recognition Module could for example determine that a user made a body part gesture to drop or throw a virtual object onto one or the other of the multiple screens, or that the user made a body part gesture to move the virtual object to a bezel of one or the other of the multiple screens. The Object and Gesture Recognition System may be coupled to a camera or camera array, a microphone or microphone array, a touch screen or touch surface, or a pointing device, or some combination of these items, to detect gestures and commands from the user.

The touch screen or touch surface of the Object and Gesture Recognition System may include a touch screen sensor. Data from the sensor may be fed to hardware, software, firmware or a combination of the same to map the touch gesture of a user's hand on the screen or surface to a corresponding dynamic behavior of a virtual object. The sensor date may be used to momentum and inertia factors to allow a variety of momentum behavior for a virtual object based on input from the user's hand, such as a swipe rate of a user's finger relative to the screen. Pinching gestures may be interpreted as a command to lift a virtual object from the display screen, or to begin generating a virtual binding associated with the virtual object or to zoom in or out on a display. Similar commands may be generated by the Object and Gesture Recognition System using one or more cameras without the benefit of a touch surface.

The Direction of Attention Module 623 may be equipped with cameras or other sensors to track the position or orientation of a user's face or hands. When a gesture or voice command is issued, the system can determine the appropriate screen for the gesture. In one example, a camera is mounted near each display to detect whether the user is facing that display. If so, then the direction of attention module information is provided to the Object and Gesture Recognition Module 622 to ensure that the gestures or commands are associated with the appropriate library for the active display. Similarly, if the user is looking away from all of the screens, then commands can be ignored.

The Device Proximity Detection Module 625 can use proximity sensors, compasses, GPS (global positioning system) receivers, personal area network radios, and other types of sensors, together with triangulation and other techniques to determine the proximity of other devices. Once a nearby device is detected, it can be registered to the system and its type can be determined as an input device or a display device or both. For an input device, received data may then be applied to the Object Gesture and Recognition System 622. For a display device, it may be considered by the Adjacent Screen Perspective Module 607.

The Virtual Object Behavior Module 604 is adapted to receive input from the Object Velocity and Direction Module, and to apply such input to a virtual object being shown in the display. Thus, for example, the Object and Gesture Recognition System would interpret a user gesture and by mapping the captured movements of a user's hand to recognized movements, the Virtual Object Tracker Module would associate the virtual object's position and movements to the movements as recognized by Object and Gesture Recognition System, the Object and Velocity and Direction Module would capture the dynamics of the virtual object's movements, and the Virtual Object Behavior Module would receive the input from the Object and Velocity and Direction Module to generate data that would direct the movements of the virtual object to correspond to the input from the Object and Velocity and Direction Module.

The Virtual Object Tracker Module 606 on the other hand may be adapted to track where a virtual object should be located in three-dimensional space in a vicinity of a display, and which body part of the user is holding the virtual object, based on input from the Object and Gesture Recognition Module. The Virtual Object Tracker Module 606 may for example track a virtual object as it moves across and between screens and track which body part of the user is holding that virtual object. Tracking the body part that is holding the virtual object allows a continuous awareness of the body part's air movements, and thus an eventual awareness as to whether the virtual object has been released onto one or more screens.

The Gesture to View and Screen Synchronization Module 608, receives the selection of the view and screen or both from the Direction of Attention Module 623 and, in some cases, voice commands to determine which view is the active view and which screen is the active screen. It then causes the relevant gesture library to be loaded for the Object and Gesture Recognition System 622. Various views of an application on one or more screens can be associated with alternative gesture libraries or a set of gesture templates for a given view. As an example, in FIG. 1A, a pinch-release gesture launches a torpedo, but in FIG. 1B, the same gesture launches a depth charge.

The Adjacent Screen Perspective Module 607, which may include or be coupled to the Device Proximity Detection Module 625, may be adapted to determine an angle and position of one display relative to another display. A projected display includes, for example, an image projected onto a wall or screen. The ability to detect a proximity of a nearby screen and a corresponding angle or orientation of a display projected therefrom may for example be accomplished with either an infrared emitter and receiver, or electromagnetic or photo-detection sensing capability. For technologies that allow projected displays with touch input, the incoming video can be analyzed to determine the position of a projected display and to correct for the distortion caused by displaying at an angle. An accelerometer, magnetometer, compass, or camera can be used to determine the angle at which a device is being held while infrared emitters and cameras could allow the orientation of the screen device to be determined in relation to the sensors on an adjacent device. The Adjacent Screen Perspective Module 607 may, in this way, determine coordinates of an adjacent screen relative to its own screen coordinates. Thus, the Adjacent Screen Perspective Module may determine which devices are in proximity to each other, and further potential targets for moving one or more virtual objects across screens. The Adjacent Screen Perspective Module may further allow the position of the screens to be correlated to a model of three-dimensional space representing all of the existing objects and virtual objects.

The Object and Velocity and Direction Module 603 may be adapted to estimate the dynamics of a virtual object being moved, such as its trajectory, velocity (whether linear or angular), momentum (whether linear or angular), etc. by receiving input from the Virtual Object Tracker Module. The Object and Velocity and Direction Module may further be adapted to estimate dynamics of any physics forces, by for example estimating the acceleration, deflection, degree of stretching of a virtual binding, etc. and the dynamic behavior of a virtual object once released by a user's body part. The Object and Velocity and Direction Module may also use image motion, size and angle changes to estimate the velocity of objects, such as the velocity of hands and fingers

The Momentum and Inertia Module 602 can use image motion, image size, and angle changes of objects in the image plane or in a three-dimensional space to estimate the velocity and direction of objects in the space or on a display. The Momentum and Inertia Module is coupled to the Object and Gesture Recognition System 622 to estimate the velocity of gestures performed by hands, fingers, and other body parts and then to apply those estimates to determine momentum and velocities to virtual objects that are to be affected by the gesture.

The 3D Image Interaction and Effects Module 605 tracks user interaction with 3D images that appear to extend out of one or more screens. The influence of objects in the z-axis (towards and away from the plane of the screen) can be calculated together with the relative influence of these objects upon each other. For example, an object thrown by a user gesture can be influenced by 3D objects in the foreground before the virtual object arrives at the plane of the screen. These objects may change the direction or velocity of the projectile or destroy it entirely. The object can be rendered by the 3D Image Interaction and Effects Module in the foreground on one or more of the displays. As illustrated, various components, such as components 601, 602, 603, 604, 605. 606, 607, and 608 are connected via an interconnect or a bus, such as bus 609.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system for facilitating hybrid communication according to embodiments and examples described herein.

Some embodiments pertain to Example 1 that includes an apparatus to facilitate enhanced viewing experience, the apparatus comprising: detection/capturing logic to facilitate a capturing device to capture data of a scene, wherein the data includes a video having at least one of a two-and-a-half-dimensional video (2.5D) or a three-dimensional (3D) video; configuration/processing logic to process, in real-time, the data to generate contents representing a 3D rendering of the data; and application/execution logic to facilitate a display device to render, in real-time, the contents.

Example 2 includes the subject matter of Example 1, further comprising segmentation logic to segment the data of the scene by extracting one or more objects of interest from the scene to obtain full texture and depth of the static background in the scene.

Example 3 includes the subject matter of Examples 1-2, wherein the captured data is received as an input of red, green, blue, depth (RGB-D) video have color and depth as captured by the capturing device wherein the captured data further comprises one or more still photographs of the scene.

Example 4 includes the subject matter of Examples 1-3, wherein the configuration/processing logic is further to generate a 3D model that includes the background and one or more objects at relative depth to offer the 3D rendering of the data such that depth resolution of the 3D model matching that of the captured data.

Example 5 includes the subject matter of Examples 1-4, wherein the contents comprise integral media contents, wherein the display device comprises an integral display, and wherein the capturing device comprises one or more depth-sensing cameras, wherein the integral media contents are prepared by performing views production by relative shits, interleaving, scene configuration, and display configuration.

Example 6 includes the subject matter of Examples 1-5, wherein the contents are rendered in real-time in performing one or more tasks relating to one or more communication or viewing applications, wherein the applications include one or more of a video conferencing application, video telephonic application, a live chat application, and a social media application.

Example 7 includes the subject matter of Examples 1-6, wherein the apparatus comprises one or more processors including a graphics processor, wherein the graphics processor is co-located with an application processor on a common semiconductor package.

Some embodiments pertain to Example 8 that includes a method to facilitate enhanced viewing experience, the apparatus comprising: facilitating a capturing device to capture data of a scene, wherein the data includes a video having at least one of a two-and-a-half-dimensional video (2.5D) or a three-dimensional (3D) video; processing, in real-time, the data to generate contents representing a 3D rendering of the data; and facilitating a display device to render, in real-time, the contents.

Example 9 includes the subject matter of Example 8, further comprising segmenting the data of the scene by extracting one or more objects of interest from the scene to obtain full texture and depth of the static background in the scene.

Example 10 includes the subject matter of Examples 8-9, wherein the captured data is received as an input of red, green, blue, depth (RGB-D) video have color and depth as captured by the capturing device wherein the captured data further comprises one or more still photographs of the scene.

Example 11 includes the subject matter of Examples 8-10, further comprising generating a 3D model that includes the background and one or more objects at relative depth to offer the 3D rendering of the data such that depth resolution of the 3D model matching that of the captured data.

Example 12 includes the subject matter of Examples 8-11, wherein the contents comprise integral media contents, wherein the display device comprises an integral display, and wherein the capturing device comprises one or more depth-sensing cameras, wherein the integral media contents are prepared by performing views production by relative shits, interleaving, scene configuration, and display configuration.

Example 13 includes the subject matter of Examples 8-12, wherein the contents are rendered in real-time in performing one or more tasks relating to one or more communication or viewing applications, wherein the applications include one or more of a video conferencing application, video telephonic application, a live chat application, and a social media application.

Example 14 includes the subject matter of Examples 8-13, wherein the apparatus comprises one or more processors including a graphics processor, wherein the graphics processor is co-located with an application processor on a common semiconductor package.

Some embodiments pertain to Example 15 that includes a graphics processing system comprising a computing device having memory coupled to a processor, the processor to: facilitate a capturing device to capture data of a scene, wherein the data includes a video having at least one of a two-and-a-half-dimensional video (2.5D) or a three-dimensional (3D) video; process, in real-time, the data to generate contents representing a 3D rendering of the data; and facilitate a display device to render, in real-time, the contents.

Example 16 includes the subject matter of Example 15, wherein the processor is further to segment the data of the scene by extracting one or more objects of interest from the scene to obtain full texture and depth of the static background in the scene.

Example 17 includes the subject matter of Examples 15-16, wherein the captured data is received as an input of red, green, blue, depth (RGB-D) video have color and depth as captured by the capturing device wherein the captured data further comprises one or more still photographs of the scene.

Example 18 includes the subject matter of Examples 15-17, wherein the operations further comprise generating a 3D model that includes the background and one or more objects at relative depth to offer the 3D rendering of the data such that depth resolution of the 3D model matching that of the captured data.

Example 19 includes the subject matter of Examples 15-18, wherein the contents comprise integral media contents, wherein the display device comprises an integral display, and wherein the capturing device comprises one or more depth-sensing cameras, wherein the integral media contents are prepared by performing views production by relative shits, interleaving, scene configuration, and display configuration.

Example 20 includes the subject matter of Examples 15-19, wherein the contents are rendered in real-time in performing one or more tasks relating to one or more communication or viewing applications, wherein the applications include one or more of a video conferencing application, video telephonic application, a live chat application, and a social media application.

Example 21 includes the subject matter of Examples 15-20, wherein the processor comprises a graphics processor, wherein the graphics processor is co-located with an application processor on a common semiconductor package.

Example 22 includes at least one non-transitory or tangible machine-readable medium comprising a plurality of instructions, when executed on a computing device, to implement or perform a method as claimed in any of claims or examples 8-14.

Example 23 includes at least one machine-readable medium comprising a plurality of instructions, when executed on a computing device, to implement or perform a method as claimed in any of claims or examples 8-14.

Example 24 includes a system comprising a mechanism to implement or perform a method as claimed in any of claims or examples 8-14.

Example 25 includes an apparatus comprising means for performing a method as claimed in any of claims or examples 8-14.

Example 26 includes a computing device arranged to implement or perform a method as claimed in any of claims or examples 8-14.

Example 27 includes a communications device arranged to implement or perform a method as claimed in any of claims or examples 8-14.

Example 28 includes at least one machine-readable medium comprising a plurality of instructions, when executed on a computing device, to implement or perform a method or realize an apparatus as claimed in any preceding claims.

Example 29 includes at least one non-transitory or tangible machine-readable medium comprising a plurality of instructions, when executed on a computing device, to implement or perform a method or realize an apparatus as claimed in any preceding claims.

Example 30 includes a system comprising a mechanism to implement or perform a method or realize an apparatus as claimed in any preceding claims.

Example 31 includes an apparatus comprising means to perform a method as claimed in any preceding claims.

Example 32 includes a computing device arranged to implement or perform a method or realize an apparatus as claimed in any preceding claims.

Example 33 includes a communications device arranged to implement or perform a method or realize an apparatus as claimed in any preceding claims.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. An apparatus comprising:
detection/capturing logic to facilitate a capturing device to capture data of a scene, wherein the data includes a video having at least one of a two-and-a-half-dimensional video (2.5D) or a three-dimensional (3D) video;
configuration/processing logic to process, in real-time, the data to generate contents representing a 3D rendering of the data; and
application/execution logic to facilitate a display device to render, in real-time, the contents.

2. The apparatus of claim 1, further comprising segmentation logic to segment the data of the scene by extracting one or more objects of interest from the scene to obtain full texture and depth of the static background in the scene.

3. The apparatus of claim 1, wherein the captured data is received as an input of red, green, blue, depth (RGB-D) video have color and depth as captured by the capturing device wherein the captured data further comprises one or more still photographs of the scene.

4. The apparatus of claim 1, wherein the configuration/processing logic is further to generate a 3D model that includes the background and one or more objects at relative depth to offer the 3D rendering of the data such that depth resolution of the 3D model matching that of the captured data.

5. The apparatus of claim 1, wherein the contents comprise integral media contents, wherein the display device comprises an integral display, and wherein the capturing device comprises one or more depth-sensing cameras, wherein the integral media contents are prepared by performing views production by relative shits, interleaving, scene configuration, and display configuration.

6. The apparatus of claim 1, wherein the contents are rendered in real-time in performing one or more tasks relating to one or more communication or viewing applications, wherein the applications include one or more of a video conferencing application, video telephonic application, a live chat application, and a social media application.

7. The apparatus of claim 1, wherein the apparatus comprises one or more processors including a graphics processor, wherein the graphics processor is co-located with an application processor on a common semiconductor package.

8. A method comprising:
facilitating a capturing device to capture data of a scene, wherein the data includes a video having at least one of a two-and-a-half-dimensional video (2.5D) or a three-dimensional (3D) video;
processing, in real-time, the data to generate contents representing a 3D rendering of the data; and
facilitating a display device to render, in real-time, the contents.

9. The method of claim 8, further comprising segmenting the data of the scene by extracting one or more objects of interest from the scene to obtain full texture and depth of the static background in the scene.

10. The method of claim 8, wherein the captured data is received as an input of red, green, blue, depth (RGB-D) video have color and depth as captured by the capturing device wherein the captured data further comprises one or more still photographs of the scene.

11. The method of claim 8, further comprising generating a 3D model that includes the background and one or more objects at relative depth to offer the 3D rendering of the data such that depth resolution of the 3D model matching that of the captured data.

12. The method of claim 8, wherein the contents comprise integral media contents, wherein the display device comprises an integral display, and wherein the capturing device comprises one or more depth-sensing cameras, wherein the integral media contents are prepared by performing views production by relative shits, interleaving, scene configuration, and display configuration.

13. The method of claim 8, wherein the contents are rendered in real-time in performing one or more tasks relating to one or more communication or viewing applications, wherein the applications include one or more of a video conferencing application, video telephonic application, a live chat application, and a social media application.

14. The method of claim 8, wherein the apparatus comprises one or more processors including a graphics processor, wherein the graphics processor is co-located with an application processor on a common semiconductor package.

15. At least one machine-readable medium comprising instructions which, when executed by a computing device, cause the computing device to perform operations comprising:
facilitating a capturing device to capture data of a scene, wherein the data includes a video having at least one of a two-and-a-half-dimensional video (2.5D) or a three-dimensional (3D) video;
processing, in real-time, the data to generate contents representing a 3D rendering of the data; and
facilitating a display device to render, in real-time, the contents.

16. The machine-readable medium of claim 15, wherein the operations further comprise segmenting the data of the scene by extracting one or more objects of interest from the scene to obtain full texture and depth of the static background in the scene.

17. The machine-readable medium of claim 15, wherein the captured data is received as an input of red, green, blue, depth (RGB-D) video have color and depth as captured by the capturing device wherein the captured data further comprises one or more still photographs of the scene.

18. The machine-readable medium of claim 15, wherein the operations further comprise generating a 3D model that includes the background and one or more objects at relative depth to offer the 3D rendering of the data such that depth resolution of the 3D model matching that of the captured data.

19. The machine-readable medium of claim 15, wherein the contents comprise integral media contents, wherein the display device comprises an integral display, and wherein the capturing device comprises one or more depth-sensing cameras, wherein the integral media contents are prepared by performing views production by relative shits, interleaving, scene configuration, and display configuration.

20. The machine-readable medium of claim 15, wherein the contents are rendered in real-time in performing one or more tasks relating to one or more communication or viewing applications, wherein the applications include one or more of a video conferencing application, video telephonic application, a live chat application, and a social media application, wherein the apparatus comprises one or more processors including a graphics processor, wherein the graphics processor is co-located with an application processor on a common semiconductor package.
